(19) United States
(12) Patent Application Publication
(10) Pub. No.: US 2011/0038443 A1
(43) Pub. Date: Feb. 17, 2011

(54) COMMUNICATION APPARATUS, COMMUNICATION METHOD THEREFOR, PROGRAM, AND STORAGE MEDIUM

(75) Inventor: Tatsuhiko Sakai, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/989,070

(22) PCT Filed: Apr. 14, 2009
(86) PCT No.: PCT/JP2009/001725

§ 371 Date: Oct. 21, 2010

(30) Foreign Application Priority Data
Apr. 28, 2008 (JP) 2008-117298

(51) Int. Cl. H04L 27/06

(52) U.S. Cl. 375/340

(57) ABSTRACT

When a button for setting a communication parameter is operated in a communication apparatus that has a communication-parameter receiving function (receiving apparatus) and that is currently participating in a network, the communication apparatus (receiving apparatus) sends a start notification message to another apparatus currently participating in the network. Upon receipt of the start notification message, a providing apparatus currently participating in the network starts a communication-parameter providing process.

### TECHNICAL FIELD

The present invention relates to communication apparatuses, communication methods therefor, programs, and storage media.

### BACKGROUND ART

In wireless communication represented by wireless local area networks (LANs) conforming to the Institute of Electrical and Electronics Engineers (IEEE) 802.11 standard series, there are many setting items that must be set prior to use.

For example, as setting items, there are communication parameters needed to perform wireless communication, such as the Service Set Identifier (SSID) which is a network identifier, an encryption method, an encryption key, an authentication method, and an authentication key. It is very complicated for the user to manually enter and set these communication parameters.

Therefore, various manufacturers have devised automatic setting methods for easily setting communication parameters in wireless devices. In these automatic setting methods, one device provides communication parameters to another device connected thereto, using a procedure and messages determined in advance between these connected devices, and accordingly the communication parameters are automatically set.

Patent Citation 1 discloses an example of automatically setting communication parameters in wireless LAN ad-hoc network mode communication (hereinafter called ad-hoc communication).

[Patent Citation 1]

Japanese Patent Laid-Open No. 2006-311139

### DISCLOSURE OF INVENTION

### Technical Problem

Now, the case of adding, by performing a communication-parameter automatic setting process, a new device to an ad-hoc network configured by automatically setting communication parameters will be considered.

In this case, a device currently participating in the network needs to provide communication parameters of the network to the new device to be added.

However, not all devices currently participating in the network can provide the communication parameters to the new device to be added. Such devices incapable of providing the communication parameters include, for example, devices having only a function of receiving communication parameters set by automatically setting communication parameters, but not having a communication-parameter providing function. Even devices having a communication-parameter providing function may not be able to perform a communication-parameter providing process because these devices might have to perform other processes.

Therefore, when a user wishes to add a device to a network, the user must select a device capable of providing communication parameters from among devices currently participating in the network and then start a communication-parameter automatic setting process. This is bothersome for the user.

The present invention provides techniques for alleviating the load on a user who must select a device in order to set communication parameters.

### Solution to Problem

The present invention provides a communication apparatus including receiving means for operating as a receiving apparatus that receives a communication parameter provided from a providing apparatus that provides a communication parameter; determining means for determining whether the communication apparatus is currently participating in a network; detecting means for detecting an operation entered by a user to give an instruction to provide or receive a communication parameter; and sending means for sending, in case that the operation is detected by the detecting means, a message for enabling the providing apparatus to provide a communication parameter to another receiving apparatus in accordance with a determination result obtained by the determining means.

### BRIEF DESCRIPTION OF DRAWINGS

FIG. 1 is a block diagram of an apparatus.

FIG. 2 is a software functional block diagram of the interior of a providing apparatus according to an embodiment of the present invention.

FIG. 3 is a software functional block diagram of the interior of a receiving apparatus according to the embodiment of the present invention.

FIG. 4 is a network configuration diagram according to the embodiment of the present invention.

FIG. 5 is a flowchart illustrating a notification operation of a communication-parameter receiving apparatus according to a first embodiment.

FIG. 6 is a flowchart illustrating a communication-parameter receiving operation of a communication-parameter receiving apparatus according to the first embodiment.

FIG. 7 is a flowchart illustrating a notification operation of a communication-parameter providing apparatus according to the first embodiment.

FIG. 8 is a flowchart illustrating a communication-parameter providing operation of the communication-parameter providing apparatus according to the first embodiment.

FIG. 9 is a sequence diagram illustrating operations of an apparatus A, an apparatus B, and an apparatus C according to the first embodiment.

FIG. 10 is a flowchart illustrating a notification operation of a communication-parameter providing apparatus according to a second embodiment.

FIG. 11 is a flowchart illustrating a notification operation of a communication-parameter receiving apparatus according to the second embodiment.

FIG. 12 is a sequence diagram illustrating operations of an apparatus A, an apparatus B, and an apparatus C according to the second embodiment.

### DESCRIPTION OF EMBODIMENTS

A communication apparatus according to an embodiment of the present invention will now herein be described in detail with reference to the drawings. Although the following description concerns an example in which a wireless LAN system conforming to the IEEE 802.11 series is employed, the communication configuration is not necessarily limited to a wireless LAN conforming to IEEE 802.11.

An exemplary hardware configuration in the embodiment will be described.

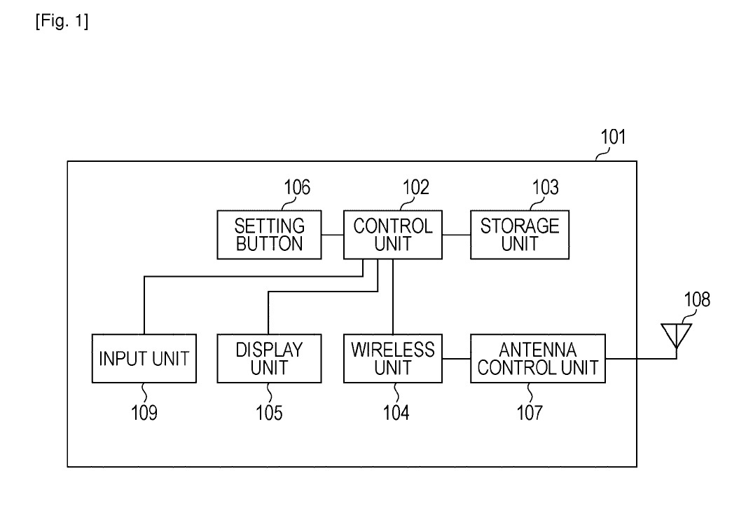

FIG. 1 is a block diagram illustrating an exemplary structure of each apparatus, which will be described later, according to the embodiment of the present invention. FIG. 1 illustrates the entirety of an apparatus 101. A control unit 102 controls the entire apparatus 101 by executing a control program stored in a storage unit 103. The control unit 102 additionally controls setting of communication parameters with another apparatus. The storage unit 103 stores the control program executed by the control unit 102 and various items of information, such as communication parameters. Various operations described later are performed by executing, with the control unit 102, the control program stored in the storage unit 103.

A wireless unit 104 performs wireless communication. A display unit 105 performs various displays. The display unit 105 has a function of outputting information in a visually recognizable manner, as in a liquid crystal display (LCD) or a light-emitting diode (LED), or/and a function of outputting sounds, as in a loudspeaker.

A setting button 106 is used for triggering or starting a communication-parameter setting process. Upon detection of an operation entered by a user using the setting button 106, the control unit 102 performs a process described later.

An antenna control unit 107 controls an antenna 108. An input unit 109 is operated by the user to enter various instructions and commands.

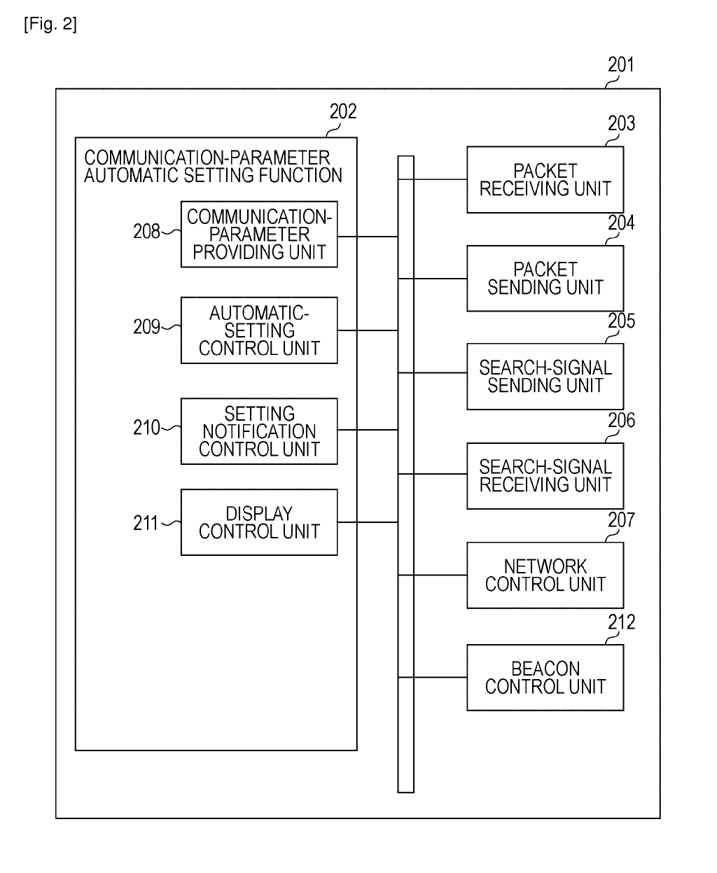

FIG. 2 is a block diagram illustrating an exemplary configuration of software function blocks performed by an apparatus that provides communication parameters (hereinafter called a providing apparatus) in a communication-parameter setting operation described later.

FIG. 2 illustrates the entirety of an apparatus 201. The apparatus 201 includes a communication-parameter automatic setting function block 202. In this embodiment, automatic setting of communication parameters needed to perform wireless communication, such as the SSID which is a network identifier, an encryption method, an encryption key, an authentication method, and an authentication key, is performed.

A packet receiving unit 203 receives packets related to various communications. Receiving of a beacon (broadcast signal) is performed by the packet receiving unit 203. A packet sending unit 204 sends packets related to various communications. Sending of a beacon is performed by the packet sending unit 204. Various items of information (self-information) of the sending source device are added to a beacon.

A search-signal sending unit 205 controls sending of a device search signal, such as a probe request. A probe request may be a network search signal for searching for a desired network. Sending of a probe request is performed by the search-signal sending unit 205. Also, sending of a probe response, which is a response signal to a received probe request, is performed by the search-signal sending unit 205.

A search-signal receiving unit 206 controls receiving of a device search signal, such as a probe request, from another apparatus. Receiving of a probe request is performed by the search-signal receiving unit 206. Also, receiving of a probe response is performed by the search-signal receiving unit 206. Various items of information (self-information) of the sending source device are added to a device search signal and a response signal in response thereto.

A network control unit 207 controls a network connection. A process of connecting to a wireless LAN ad-hoc network, for example, is performed by the network control unit 207.

In the communication-parameter automatic setting function block 202, a communication-parameter providing unit 208 provides communication parameters to a partner device.

An automatic-setting control unit 209 controls various protocols in communication-parameter automatic setting. A communication-parameter automatic setting process, which will be described later, is performed by the communication-parameter providing unit 208 under control of the automatic-setting control unit 209. In addition, the automatic-setting control unit 209 determines whether a time elapsed since the start of a communication-parameter automatic setting process has exceeded a time limit of the setting process. When it is determined that the elapsed time has exceeded the time limit, the automatic-setting control unit 209 performs control to terminate the setting process.

A setting notification control unit 210 controls a process of sending notifications of the start and the end of a communication-parameter automatic setting process. A process of sending/receiving a start notification message, a start notification response message, and a completion notification message in the providing apparatus, which will be described later, is performed by the setting notification control unit 210.

A display control unit 211 controls display relating to automatic setting of communication parameters. At the time of successful completion of or occurrence of an error in an automatic setting process, the display control unit 211 sends a notification to a user using the display unit 105.

A beacon control unit 212 controls a sending timing of a beacon (broadcast signal). Now, a beacon sending algorithm in an IEEE 802.11 wireless LAN ad-hoc network will be described.

In the ad-hoc network, beacons are sent by all apparatuses included in the network in an autonomous distributed manner. A beacon sending interval (beacon period) is to be determined by the apparatus that first configured the ad-hoc network. In general, a beacon is sent from any of the apparatuses at an interval of about 100 ms.

A beacon sending timing is controlled by a parameter called a contention window (or a random number generation range; hereinafter abbreviated as “CW”). Each apparatus in the network obtains a random value (CWrand) from 0 to CW at the time of sending a beacon. A waiting time (back-off time) until sending a beacon is obtained by multiplying CWrand by a predetermined interval (slot time). Next, the waiting time until sending a beacon is decremented by the slot time, and, when the waiting time becomes zero, a beacon is sent. If an apparatus receives a beacon from another apparatus before sending a beacon, the apparatus stops sending a beacon. In this way, contention of beacons sent from apparatuses can be avoided. Each apparatus in the ad-hoc network selects a random number from 0 to CW. Among apparatuses included in the network, an apparatus that has selected the smallest CWrand sends a beacon.

For example, when the same CW, serving as an initial value, is set to all apparatuses, the probability of sending a beacon is the same for all apparatuses. As a result, the number of beacons sent per unit time is substantially the same for all apparatuses. In other words, the frequency (rate) of sending a beacon is the same for all apparatuses. In contrast, when one apparatus in the network sets CW to a value less than the initial value, the probability of sending a beacon becomes higher for this apparatus than for any other apparatus. That is, CW is a parameter for determining the probability of sending a beacon or a parameter for determining the number of beacons sent per unit time. In other words, CW is a parameter for determining a beacon sending rate of each apparatus. That is, CW is a parameter for determining a beacon sending timing or a parameter for determining a waiting time until sending a beacon.

The value of CW is changeable within the range from CWmin (minimum value) to CWmax (maximum value). When CW is set to CWmin, the number of beacons sent per unit time is maximized. When CWinit (>CWmin) is set as an initial value and when no communication-parameter automatic setting process is being performed, a beacon is sent using the initial value.

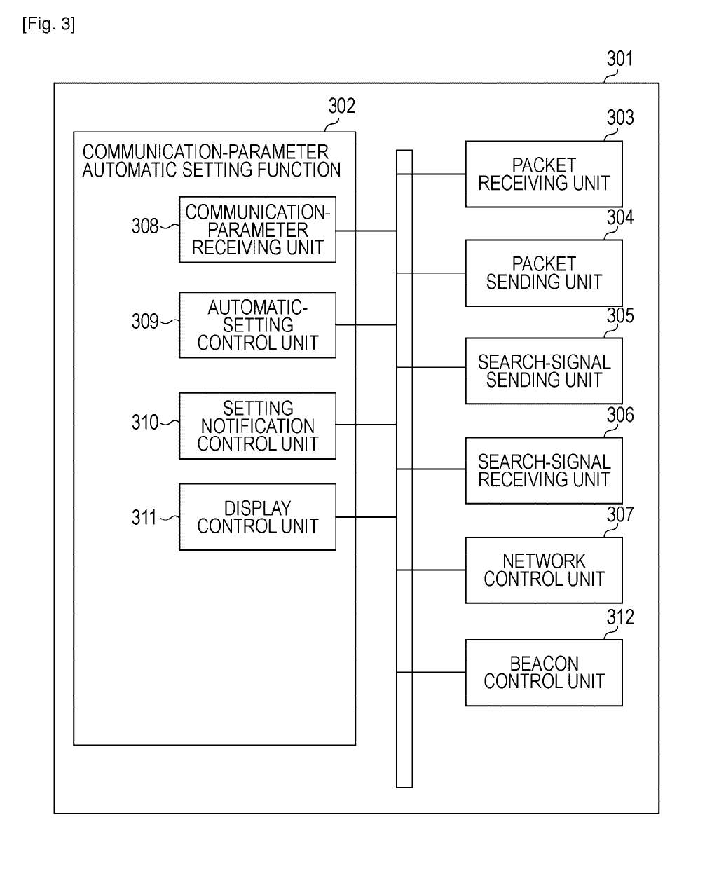

FIG. 3 is a block diagram illustrating an exemplary configuration of software function blocks performed by an apparatus that receives communication parameters (hereinafter called a receiving apparatus) in a communication-parameter setting operation described later.

FIG. 3 illustrates the entirety of an apparatus 301. The apparatus 301 includes a communication-parameter automatic setting function block 302. In this embodiment, automatic setting of communication parameters needed to perform wireless communication, such as the SSID which is a network identifier, an encryption method, an encryption key, an authentication method, and an authentication key, is performed.

A packet receiving unit 303 receives packets related to various communications. Receiving of a beacon (broadcast signal) is performed by the packet receiving unit 303. A packet sending unit 304 sends packets related to various communications. Sending of a beacon is performed by the packet sending unit 304. Various items of information (self-information) of the sending source device are added to a beacon.

A search-signal sending unit 305 controls sending of a device search signal, such as a probe request. A probe request may be a network search signal for searching for a desired network. Sending of a probe request is performed by the search-signal sending unit 305. Also, sending of a probe response, which is a response signal to a received probe request, is performed by the search-signal sending unit 305.

A search-signal receiving unit 306 controls receiving of a device search signal, such as a probe request, from another apparatus. Receiving of a probe request is performed by the search-signal receiving unit 306. Also, receiving of a probe response is performed by the search-signal receiving unit 306. Various items of information (self-information) of the sending source device are added to a device search signal and a response signal in response thereto.

A network control unit 307 controls a network connection. A process of connecting to a wireless LAN ad-hoc network, for example, is performed by the network control unit 307.

In the communication-parameter automatic setting function block 302, a communication-parameter receiving unit 308 receives communication parameters from a partner device.

An automatic-setting control unit 309 controls various protocols in communication-parameter automatic setting. A communication-parameter automatic setting process, which will be described later, is performed by the communication-parameter receiving unit 308 under control of the automatic-setting control unit 309. In addition, the automatic-setting control unit 309 determines whether a time elapsed since the start of a communication-parameter automatic setting process has exceeded a time limit of the setting process. When it is determined that the elapsed time has exceeded the time limit, the automatic-setting control unit 309 performs control to terminate the setting process.

A setting notification control unit 310 controls a process of sending notifications of the start and the end of a communication-parameter automatic setting process. A process of sending/receiving a start notification message, a start notification response message, and a completion notification message in the receiving apparatus, which will be described later, is performed by the setting notification control unit 310.

A display control unit 311 controls display relating to automatic setting of communication parameters. At the time of successful completion of or occurrence of an error in an automatic setting process, the display control unit 311 sends a notification to a user using the display unit 105.

A beacon control unit 312 controls a sending timing of a beacon (broadcast signal).

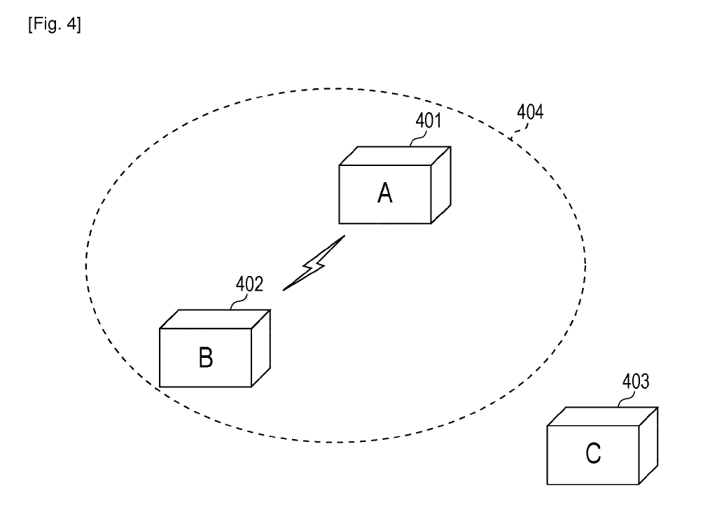

FIG. 4 is a diagram illustrating a first communication apparatus A401 (hereinafter called an apparatus A), a second communication apparatus B402 (hereinafter called an apparatus B), a third communication apparatus C403 (hereinafter called an apparatus C), and a network 404. The apparatus A has a function of providing communication parameters and has, as a providing apparatus, the foregoing configurations illustrated in FIGS. 1 and 2. The apparatus B and the apparatus C have a function of receiving communication parameters and have, as receiving apparatuses, the configurations illustrated in FIGS. 1 and 3. Note that communication parameters have already been automatically set between the apparatuses A and B, and the apparatus B is participating in the network 404 using the communication parameters received from the apparatus A.

Now, the case where, when the apparatus C wishes to participate in the network 404 including the apparatuses A and B, setting buttons of the apparatuses B and C are operated will be considered.

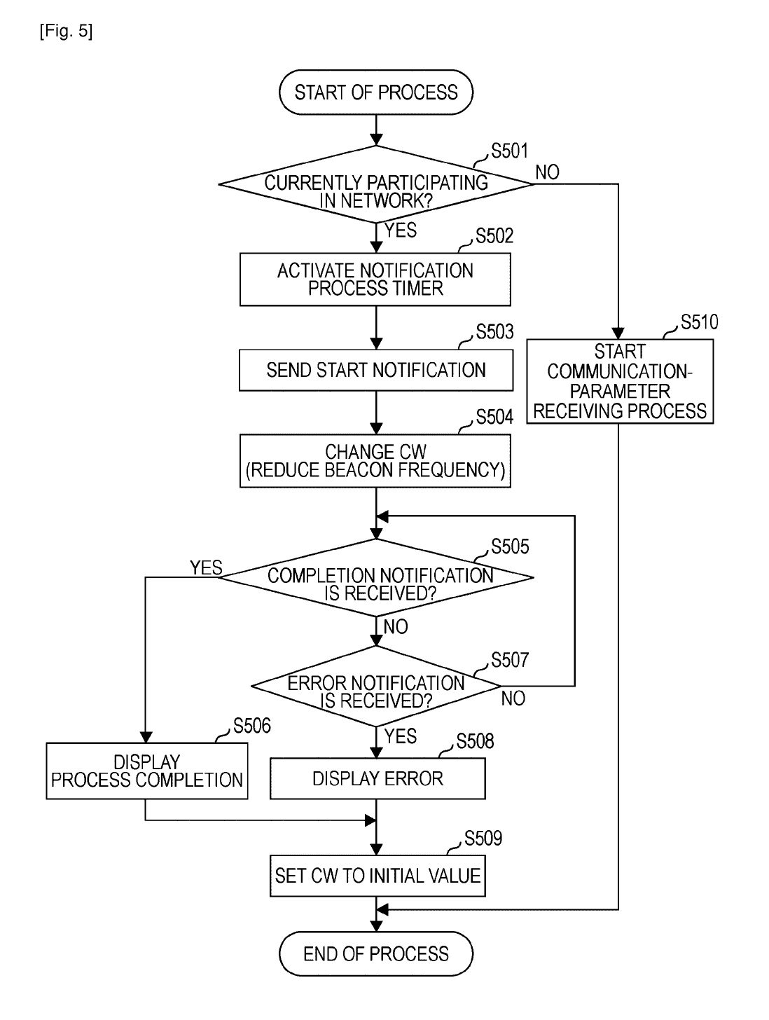

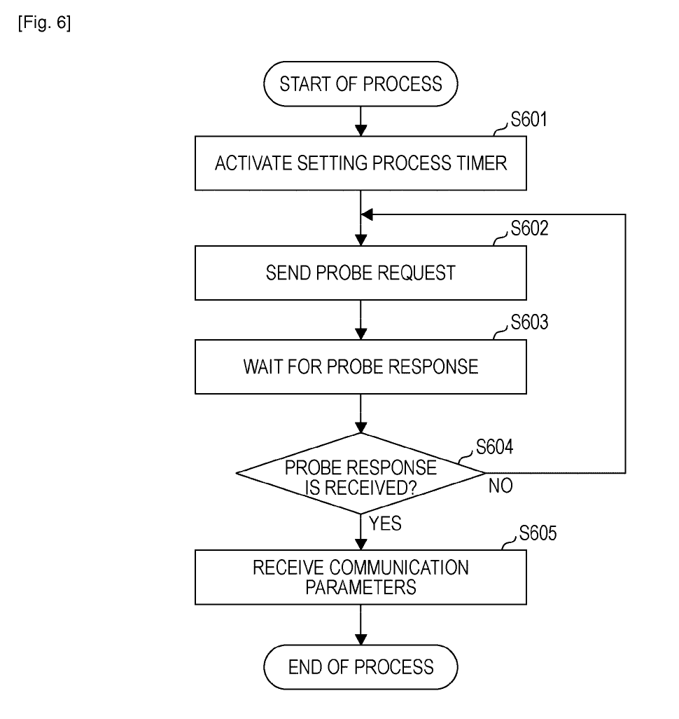

FIG. 6 is a flowchart illustrating a communication-parameter receiving operation of a receiving apparatus in the embodiment. When a communication-parameter receiving process is started in step S510 of FIG. 5 described later, the process illustrated in FIG. 6 is started.

After the process is started, the receiving apparatus activates a timer for determining whether a time limit of the communication-parameter receiving process has reached (S601). When this timer expires, the communication-parameter setting process is terminated even during the processing in steps S602 to S605, which will be described later.

The receiving apparatus sends a probe request (S602) and waits for a certain time for a probe response including additional information indicating communication-parameter automatic setting to be sent from a providing apparatus (S603). A probe response including additional information indicating communication-parameter automatic setting is a probe response that is sent from a providing apparatus when the providing apparatus is currently performing a communication-parameter automatic setting process. When the providing apparatus is not currently performing an automatic setting process, the providing apparatus sends a probe response including no additional information indicating communication-parameter automatic setting. In this way, a providing apparatus that has started a communication-parameter setting process can be detected by checking a probe response.

When no probe response including additional information is received in the certain time (S604), the flow returns to step S602, and a probe request is sent again.

When a probe response including additional information is received, the receiving apparatus requests the providing apparatus to provide communication parameters. This request is made by sending a message for starting communication-parameter automatic setting. The receiving apparatus receives communication parameters from the providing apparatus and stores the communication parameters in the storage unit 103 (S605). By using the stored communication parameters, the receiving apparatus can participate in the network 404 and perform data communication with apparatuses participating in the network 404.

In steps S602 to S604, a method of searching for a providing apparatus that has started a communication-parameter setting process, by waiting for reception of a probe response to a probe request (active scan), has been described. Since a providing apparatus that is currently performing a communication-parameter setting process sends a beacon including additional information indicating communication-parameter automatic setting, the receiving apparatus may use a method of waiting for the beacon to be sent for a certain time (passive scan).

FIG. 5 is a flowchart illustrating the operation of the receiving apparatus in the embodiment. When the setting button 106 of the receiving apparatus is operated, the automatic-setting control unit 309 detects this operation and starts the process illustrated in FIG. 5.

When the process is started, the receiving apparatus checks whether the receiving apparatus is currently participating in a network (S501). When it is determined that the receiving apparatus is not participating in a network, the communication-parameter receiving process illustrated in FIG. 6 is started (S510). When it is determined that the receiving apparatus is currently participating in a network, the flow proceeds to step S502. As illustrated in FIG. 4, when the setting button 106 of the apparatus B, which has received communication parameters provided from the apparatus A and is already participating in the network 404, is operated, the flow proceeds to step S502. In contrast, when the setting button 106 of the apparatus C, which has not received communication parameters, is operated, the flow proceeds to step S510. In step S502, the receiving apparatus activates a timer for determining whether a time limit of the process described in steps S503 to S509 has reached. The receiving apparatus broadcasts a start notification message indicating that communication-parameter automatic setting has started (S503). After sending the message, the receiving apparatus performs a process to reduce the frequency (rate) of sending a beacon (S504). That is, the receiving apparatus changes and sets CW to a value greater than the initial value (S504) so that the beacon sending rate becomes lower.

In an IEEE 802.11 wireless LAN ad-hoc network, it is defined that an apparatus that sends a probe response is an apparatus that sent a beacon immediately before receiving a probe request.

Therefore, in step S504, the beacon control unit 312 sets CW to a value greater than the initial value. In this way, the number of beacons sent per unit time by the receiving apparatus currently participating in the network becomes less than the number of beacons sent per unit time by a providing apparatus. As a result, when a new receiving apparatus wishing to participate in the network performs a providing-apparatus search process (S602 to S604 in FIG. 6), the new receiving apparatus can quickly detect a probe response from the providing apparatus.

As above, the frequency (probability) of sending a beacon from the providing apparatus is made higher than the frequency (probability) of sending a beacon from the receiving apparatus. As a result, when a new receiving apparatus wishing to participate in the network searches for the providing apparatus by performing active scan, the probability of the new receiving apparatus receiving a probe response from the providing apparatus becomes higher. Even in the case where the new receiving apparatus searches for the providing apparatus by performing passive scan, the probability of receiving a beacon from the providing apparatus becomes higher. As a result, the probability of the new receiving apparatus not detecting the providing apparatus before the time limit of a communication-parameter setting process can be reduced. If the new receiving apparatus wishing to participate in the network can quickly detect the providing apparatus, the time until when providing of communication parameters is completed can be reduced.

After the processing in step S504, the receiving apparatus waits for a completion notification message or an error notification message sent from the providing apparatus (S505 or S507). When a completion notification message is received, it is determined that providing of communication parameters from the providing apparatus to another receiving apparatus is completed, and a notification of the completion of the communication-parameter setting process is sent to a user using the display unit 105 (S506). In contrast, when an error notification message is received, a notification of this error in the setting process is sent to the user using the display unit 105 (S508).

After the notification is sent to the user in step S506 or S508, the beacon control unit 312 of the receiving apparatus resets CW to the initial value that existed before the change, and resets the beacon sending frequency, which was reduced in step S504, to the initial beacon sending frequency (S509).

When the timer set in step S502 expires, the receiving apparatus cancels the processing in steps S503 to S509, and sends a notification of this error in the communication-parameter setting process to the user using the display unit 105. When the value of CW is changed in step S504 at the time the timer expires, as in step S509, the beacon sending frequency is reset. The start notification message sent in step S503 is repeatedly sent until a completion notification message or an error notification message is received.

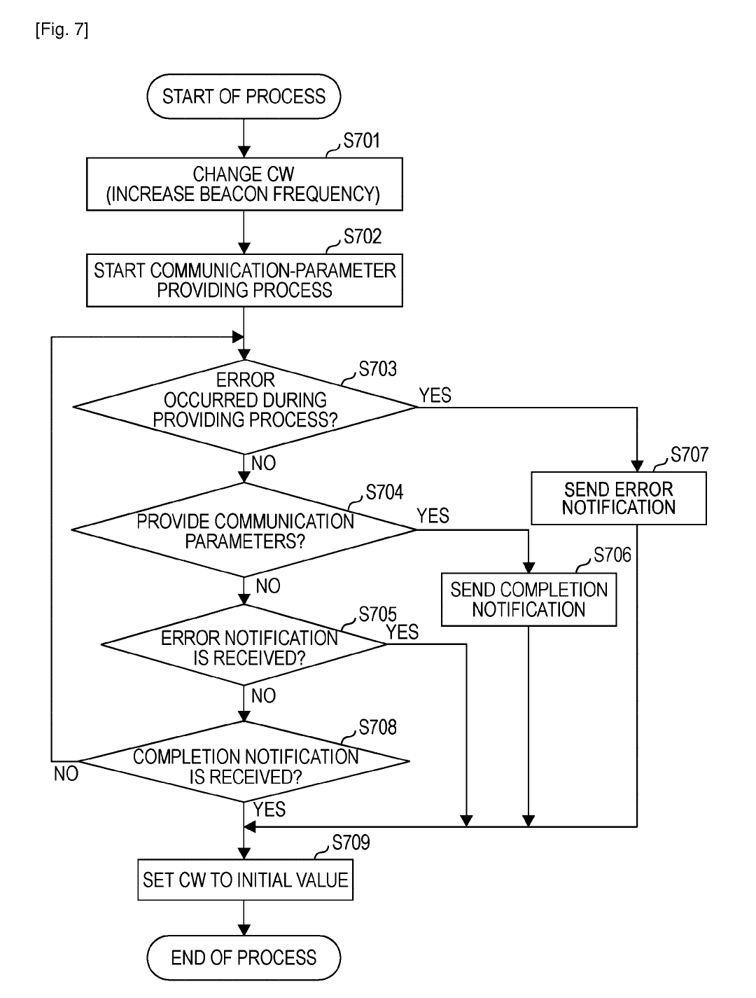

FIG. 7 is a flowchart illustrating a first providing operation of the providing apparatus in the embodiment. When the providing apparatus receives a start notification message, the process illustrated in FIG. 7 is started.

When the automatic-setting control unit 209 detects reception of a start notification message, the beacon control unit 212 of the providing apparatus sets CW to a value less than the initial value (S701). By setting CW to a value less than the initial value, the frequency (rate) of sending a beacon (the number of beacons sent) by the providing apparatus per unit time is increased (S701).

Accordingly, the number of beacons sent per unit time by the providing apparatus currently participating in the network becomes greater than the number of beacons sent per unit time by a receiving apparatus. As a result, when a new receiving apparatus wishing to participate in the network performs a providing-apparatus search process (S602 to S604 in FIG. 6), the new receiving apparatus can quickly detect a probe response from the providing apparatus.

As above, by increasing the frequency of sending a beacon by the providing apparatus, when a new receiving apparatus wishing to participate in the network searches for the providing apparatus by performing active scan, the probability of the new receiving apparatus receiving a probe response from the providing apparatus becomes higher. Even in the case where the new receiving apparatus searches for the providing apparatus by performing passive scan, the probability of receiving a beacon from the providing apparatus becomes higher. As a result, the probability of the new receiving apparatus not detecting the providing apparatus before the time limit of a communication-parameter setting process can be reduced. If the new receiving apparatus wishing to participate in the network can quickly detect the providing apparatus, the time until when providing of communication parameters is completed can be reduced.

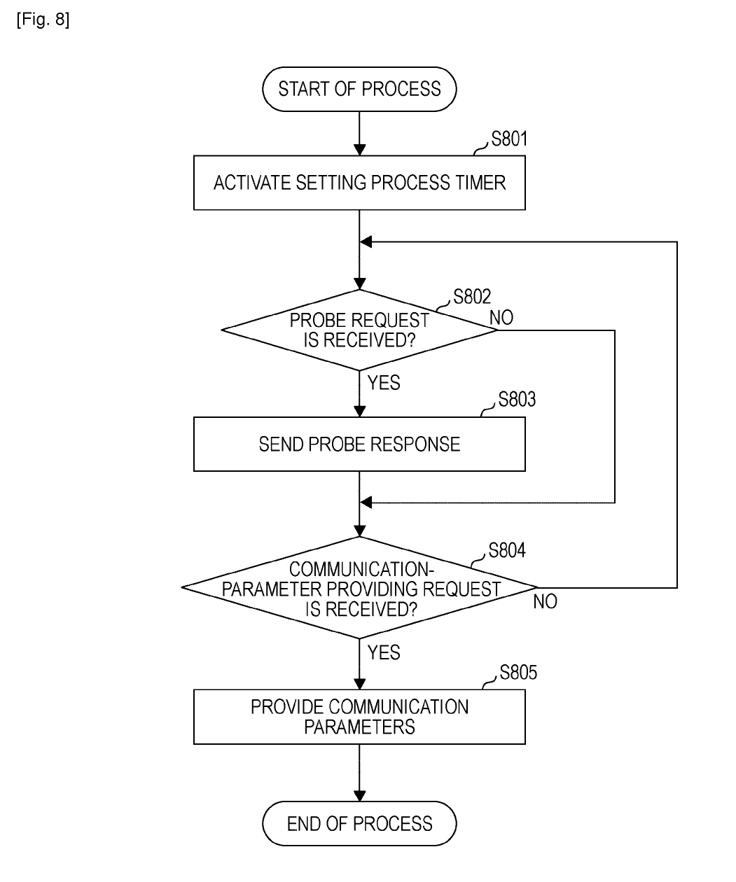

Thereafter, the providing apparatus starts a communication-parameter providing process illustrated in FIG. 8 (S702).

The providing apparatus is on standby until termination of the started providing process due to an error (S703), providing of communication parameters to a receiving apparatus (S704), or reception of an error notification message or a completion notification message from another apparatus (S705 or S708).

When the providing process is unsuccessful (S703), the providing apparatus broadcasts an error notification message (S707), and the flow proceeds to step S709. In contrast, when the communication-parameter providing process is successful and the providing apparatus provides communication parameters to a receiving apparatus (S704), the providing apparatus broadcasts a completion notification message (S706), and the flow proceeds to step S709.

When the providing apparatus receives an error notification (S705) or a completion notification (S708) from another apparatus including a receiving apparatus, the flow proceeds to step S709. In step S709, the beacon control unit 212 of the providing apparatus resets CW to the initial value, and resets the beacon sending frequency, which was increased in step S701, to the initial beacon sending frequency. Resetting of CW to the initial value may be performed at any time after the start of the providing process, such as immediately after the start of the providing process, after the completion of the providing process, or after an error. When CW is reset immediately after the start of the providing process, the frequency of sending a beacon (the number of times a beacon is sent) is reduced, whereby power consumption can be more efficiently reduced.

FIG. 8 is a flowchart illustrating a communication-parameter providing operation of the providing apparatus in the present embodiment. The process illustrated in FIG. 8 is started when the providing apparatus receives a start notification message and starts the communication-parameter providing process in step S702 in FIG. 7. Alternatively, the process illustrated in FIG. 8 is started when the setting button 106 of the providing apparatus is operated, the automatic-setting control unit 209 detects the operation, and the communication-parameter providing process is started.

After the process illustrated in FIG. 8 is started, the providing apparatus activates a timer for determining whether a time limit of the communication-parameter providing process has reached (S801). When this timer expires, the communication-parameter setting process is terminated even during the processing in steps S802 to S805, which will be described later.

After the timer is activated, the providing apparatus waits for a probe request or a communication-parameter providing request from a receiving apparatus.

When the providing apparatus receives a probe request from a receiving apparatus (S802), the providing apparatus sends a probe response including additional information indicating communication-parameter automatic setting (S803).

When the providing apparatus receives a communication-parameter providing request from a receiving apparatus (S804), the providing apparatus provides communication parameters to the receiving apparatus having sent the communication-parameter providing request (S805).

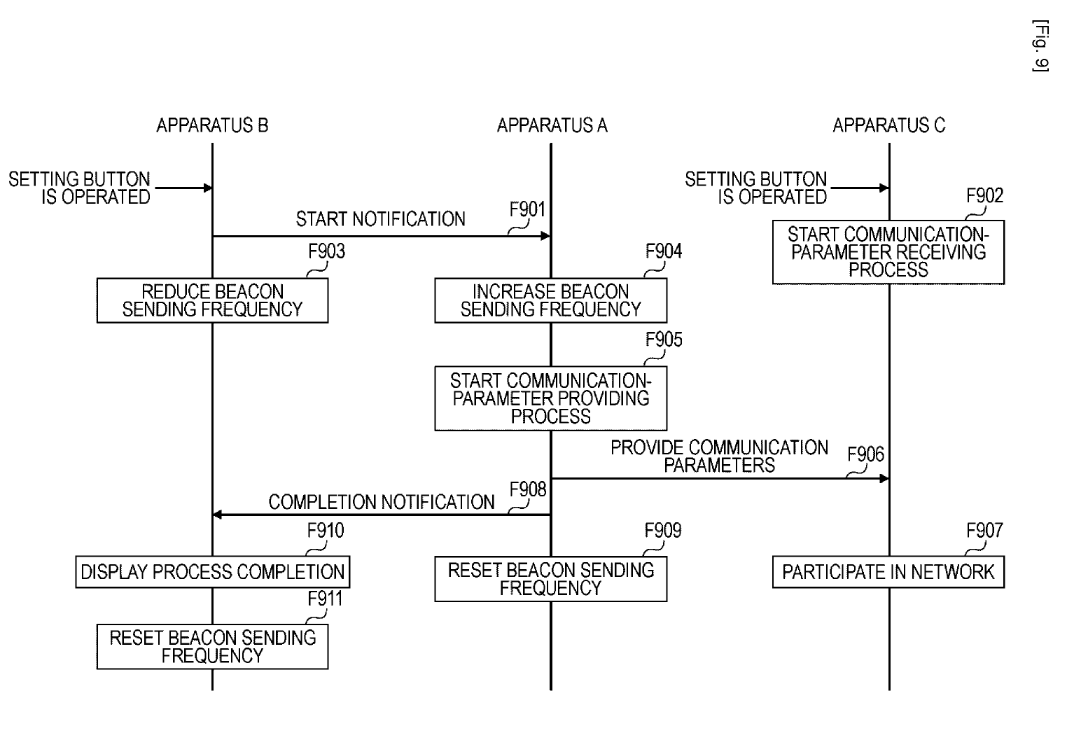

FIG. 9 is a sequence diagram illustrating the operation of each apparatus in the embodiment. It is assumed that the apparatus B has received communication parameters provided from the apparatus A and has already participated in the network 404 formed by the communication parameters. It is assumed that the apparatus C has not received communication parameters yet.

When the setting buttons of the apparatuses B and C are operated by users, the apparatus B starts the process illustrated in FIG. 5 and sends a start notification message (F901). The apparatus C starts the process illustrated in FIG. 5 and starts the communication-parameter receiving process illustrated in FIG. 6 (F902).

The apparatus B, which has sent the start notification message, changes CW to a value greater than the initial value and reduces the frequency of sending a beacon (F903).

Upon receipt of the start notification message, the apparatus A changes CW to a value less than the initial value and increases the frequency of sending a beacon (F904). Thereafter, the apparatus A starts the communication-parameter providing process (F905).

The apparatus C detects the apparatus A, which is a providing apparatus, and receives from the apparatus A communication parameters needed for communication in the network 404 (F906). The apparatus C uses the received communication parameters and participates in the network 404 (F907).

The apparatus A provides communication parameters to the apparatus C, and then sends a completion notification message (F908). After sending the completion notification message, the apparatus A resets CW to the initial value and resets the beacon sending frequency, which was increased in step F904, to the initial beacon sending frequency (F909).

Upon receipt of the completion notification message, the apparatus B sends a notification of the completion of the process to the user using the display unit 105 (F910). The apparatus B resets CW to the initial value and resets the beacon sending frequency, which was reduced in step F903, to the initial beacon sending frequency (F911).

As above, according to the present embodiment, even when the setting button of a receiving apparatus currently participating in a network is operated, the receiving apparatus sends a start notification message, whereby a communication-parameter providing process can be performed. That is, a providing apparatus that has received the start notification message automatically starts a providing process, whereby the providing process can be performed. Therefore, a user can select any apparatus, without being conscious of which apparatus is a providing apparatus or a receiving apparatus, from among apparatuses currently participating in a network, whereby the user's apparatus can receive communication parameters. That is, a new apparatus can be added to a network by operating the setting button of any apparatus, without selecting a providing apparatus. After the completion of the providing process, the increased beacon sending frequency is reset to the initial beacon sending frequency, whereby power consumption due to sending of beacons can be reduced. When the beacon sending frequency is reset to the initial beacon sending frequency immediately after the start of the communication-parameter providing process, power consumption due to sending of beacons can be more efficiently reduced.

In the foregoing description, the case where the setting button of the apparatus B, which is a receiving apparatus, is operated has been described. Next, the case where the setting button of the apparatus A, which is a providing apparatus, is operated will be described.

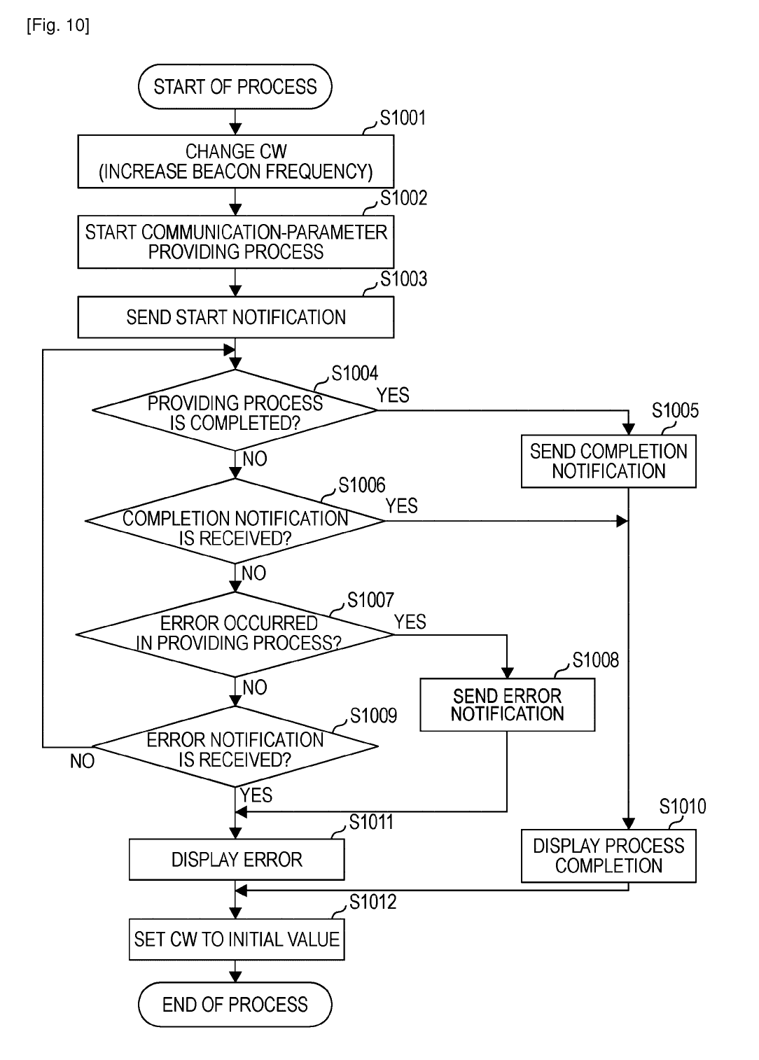

FIG. 10 is a flowchart illustrating a second providing operation of the providing apparatus. When the setting button 106 of the providing apparatus is operated, the automatic-setting control unit 209 detects this operation and starts the process illustrated in FIG. 10.

When the process is started, the beacon control unit 212 of the providing apparatus sets CW to a value less than the initial value (S1001). By setting CW to a value less than the initial value, the frequency (rate) of sending a beacon by the providing apparatus per unit time is increased (S1001).

Thereafter, the providing apparatus starts the communication-parameter providing process illustrated in FIG. 8 (S1002).

When the process is started, the providing apparatus broadcasts a start notification message indicating that communication-parameter automatic setting has started (S1003).

The providing apparatus is on standby until termination of the started providing process due to an error (S1007), providing of communication parameters to a receiving apparatus and completion of the providing (S1004), or reception of a completion notification message or an error notification message from another apparatus (S1006 or S1009).

When the providing process is successful and providing of communication parameters to a receiving apparatus is completed (S1004), the providing apparatus broadcasts a completion notification message (S1005).

When the providing apparatus sends a completion notification message in step S1005 or receives a completion notification message from another apparatus (S1006), the providing apparatus sends a notification of the completion of the process to a user using the display unit 105 (S1010).

In contrast, when the providing process is unsuccessful (S1007), the providing apparatus broadcasts an error notification message (S1008).

When the providing apparatus sends an error notification message in step S1008 or receives an error notification message from another apparatus (S1009), the providing apparatus sends a notification of the error in the process to a user using the display unit 105 (S1011).

When displaying in step S1010 or S1011 is completed, the beacon control unit 212 of the providing apparatus resets CW to the initial value, and resets the beacon sending frequency, which was increased in step S1001, to the initial beacon sending frequency (S1012). Resetting of CW to the initial value may be performed at any time after the start of the providing process, such as immediately after the start of the providing process, after the completion of the providing process, or after an error. When CW is reset immediately after the start of the providing process, the frequency of sending a beacon (the number of times a beacon is sent) is reduced, whereby power consumption due to sending of beacons can be more efficiently reduced. The start notification message sent in step S1003 is repeatedly sent until the providing process is terminated due to an error, communication parameters are provided to a receiving apparatus, or a notification message is received from another apparatus.

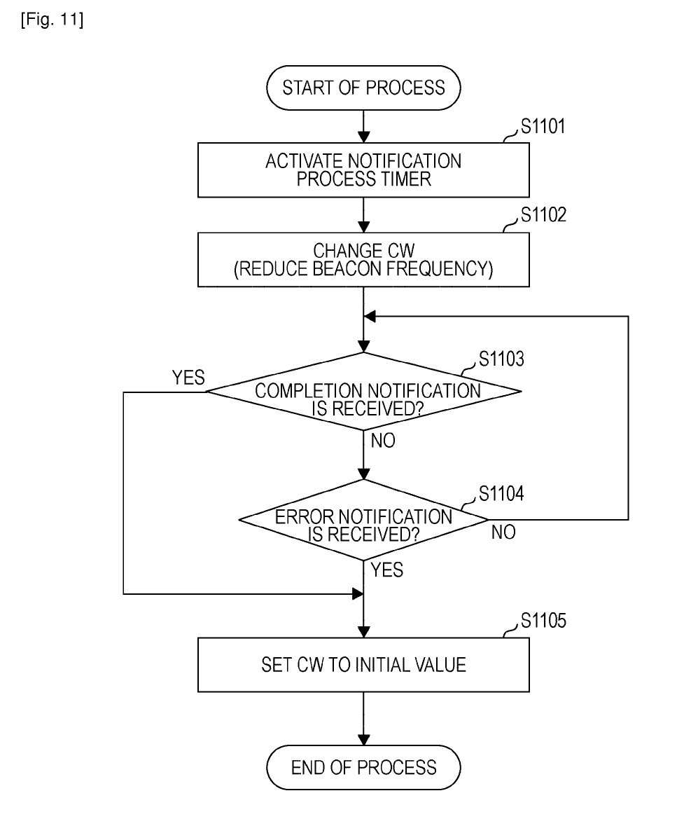

FIG. 11 is a flowchart illustrating an operation of the receiving apparatus (apparatus B) currently participating in the network. When the receiving apparatus receives a start notification message, the process illustrated in FIG. 11 is started.

When the automatic-setting control unit 309 of the receiving apparatus detects reception of the start notification message, the automatic-setting control unit 309 activates a timer for determining whether a time limit of a notification process described in steps S1102 to S1105 has reached (S1101).

The beacon control unit 312 changes CW to a value greater than the initial value (S1102) and reduces the frequency (rate) of sending a beacon.

The receiving apparatus waits for a completion notification message or an error notification message sent from the providing apparatus (S1103 or S1104). Upon receipt of a notification message, the beacon control unit 312 of the receiving apparatus resets CW to the initial value and resets the beacon sending frequency, which was reduced in step S1102, to the initial beacon sending frequency (S1105).

When the timer set in step S1101 expires, the receiving apparatus cancels the processing in steps S1102 to S1105. When the beacon sending frequency is reduced in step S1102 at the time the timer expires, as in step S1105, the beacon sending frequency is reset.

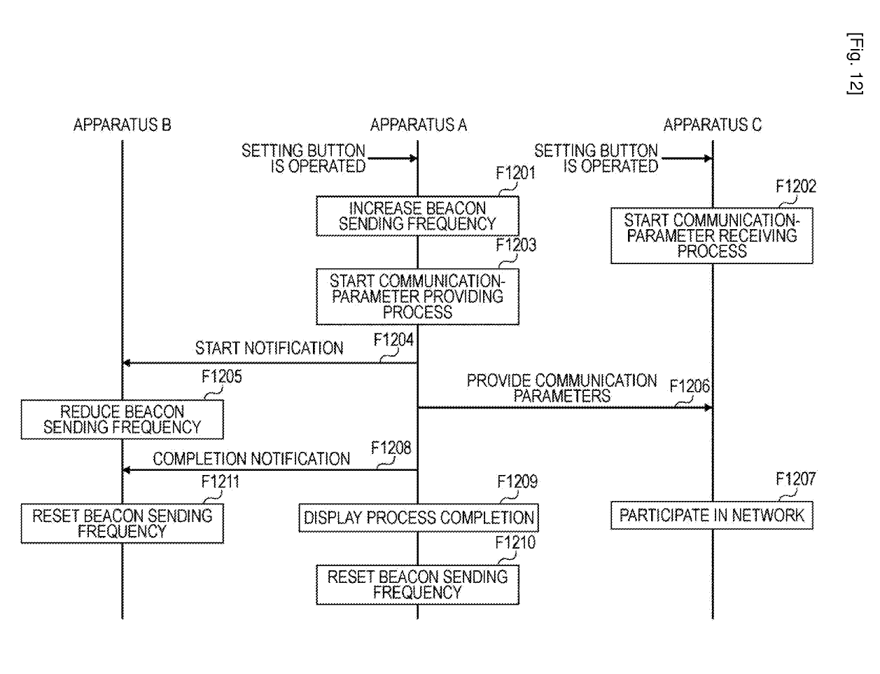

FIG. 12 is a sequence diagram illustrating the operation of each apparatus in the embodiment. It is assumed that the apparatus B has received communication parameters provided from the apparatus A and has already participated in the network 404 formed by the communication parameters. It is assumed that the apparatus C has not received communication parameters yet. When setting buttons of the apparatuses A and C are operated by users, the apparatus A starts the process illustrated in FIG. 10, increases the beacon sending frequency (F1201), and starts the communication-parameter providing process (F1203). The apparatus C starts the process illustrated in FIG. 5 and starts the communication-parameter receiving process (F1202).

The apparatus A starts the providing process and then sends a start notification message (F1204).

Upon receipt of the start notification message, the apparatus B reduces the beacon sending frequency (F1205). When the providing apparatus (apparatus A) increases the beacon sending frequency and the receiving apparatus (apparatus B) reduces the beacon sending frequency, a new receiving apparatus wishing to participate in the network (apparatus C) can more quickly detect the providing apparatus.

The apparatus C detects the apparatus A, which is a providing apparatus, and receives from the apparatus A communication parameters needed for communication in the network 404 (F1206). The apparatus C uses the received communication parameters and participates in the network 404 (F1207).

The apparatus A provides communication parameters to the apparatus C, and then sends a completion notification message (F1208). After sending the completion notification message, the apparatus A sends a notification of the completion of the process to the user using the display unit 105 (S1209). Thereafter, the apparatus A resets the beacon sending frequency, which was increased in step F1201, to the initial sending frequency (F1210). Upon receipt of the completion notification message, the apparatus B resets the beacon sending frequency, which was reduced in step F1205, to the initial sending frequency (F1211).

As above, when the providing apparatus whose setting button is operated sends a start notification message, a new receiving apparatus wishing to participate in the network can more quickly detect the providing apparatus.

The apparatus A may not be able to start a communication-parameter providing process because the apparatus A might have to perform other processes. In such a case, after the setting button of the apparatus A is operated, the apparatus A performs processing similar to steps S502 to S510 in FIG. 5.

The exemplary embodiments disclosed herein are for illustrative purposes only, and the scope of the present invention is not limited to the embodiments. Various modifications can be made to the embodiments without departing from the gist of the present invention.

In the foregoing embodiments, examples in which the value of CW is changed in order to make the number of beacons sent by a providing apparatus per unit time greater than that of other apparatuses have been described. However, other parameters may be used as long as the number of beacons sent by the providing apparatus per unit time becomes greater than that of other apparatuses. For example, when the beacon sending interval (beacon period) is changeable, the number of beacons sent per unit time can be increased by reducing the beacon sending interval of the providing apparatus.

When the setting button of the apparatus B is operated, the case where the providing apparatus (apparatus A) receives a start notification message has been described. However, an apparatus with a communication-parameter receiving function may receive a start notification message. In this case, the apparatus with a communication-parameter receiving function, which has received the start notification message, may perform the process illustrated in FIG. 11. Accordingly, when there is a plurality of providing apparatuses in a network, a new receiving apparatus wishing to participate in the network can more quickly detect a providing apparatus.

When the setting button of the apparatus A is operated, the case where the receiving apparatus (apparatus B) receives a start notification message has been described. However, an apparatus with a communication-parameter providing function may receive a start notification message. In this case, the apparatus with a communication-parameter providing function, which has received the start notification message, may perform the process illustrated in FIG. 7 and start the communication-parameter providing process. Accordingly, when there is a plurality of providing apparatuses in a network, a new receiving apparatus wishing to participate in the network can more quickly detect a providing apparatus.

In the foregoing description, it has been described that CW is changed to a value greater than or less than the initial value. Since the initial value of CW may not be the same for all apparatuses, CW may be changed to the minimum value (CWmin) or the maximum value (CWmax) within a changeable range. In this way, the frequency of sending a beacon (the number of times a beacon is sent) can be more reliably changed. Also, the start notification message has been described as a message that indicates that communication-parameter automatic setting has started. However, the start notification message can be a message that indicates that the setting button 106 has been operated. In other words, the start notification message is a message for enabling a providing apparatus to provide communication parameters to a receiving apparatus.

The description of the foregoing embodiments concerns the case where the wireless LAN conforming to IEEE 802.11 is used by way of example. However, the present invention is applicable to other wireless media such as a wireless universal serial bus (USB), MultiBand Orthogonal frequency-division multiplexing (OFDM) Alliance (MBOA), Bluetooth (registered trademark), ultra-wideband (UWB), and Zigbee. Alternatively, the present invention is applicable to a wired communication medium such as a wired LAN.

UWB includes a wireless USB, wireless 1394, WiNET, and the like.

Although the network identifier, the encryption method, the encryption key, the authentication method, and the authentication key serve as communication parameters in the description of the foregoing embodiments, other information may serve as communication parameters. That is, communication parameters include other information.

According to the present invention, a recording medium having recorded thereon a computer program code of software that realizes the foregoing functions is supplied to a system or apparatus, and a computer (central processing unit (CPU) or microprocessing unit (MPU)) of the system or apparatus reads and executes the program code stored on the recording medium.

As above, according to the present invention, a device can be added to a network without selecting, by a user, a device that provides communication parameters. This reduces the load on the user by eliminating the need to select an apparatus, whereby usability is improved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-117298, filed Apr. 28, 2008, which is hereby incorporated by reference herein in its entirety.

1. A communication apparatus, comprising:
receiving means for operating as a receiving apparatus that receives a communication parameter provided from a providing apparatus that provides a communication parameter;
determining means for determining whether the communication apparatus is currently participating in a network;
detecting means for detecting an operation entered by a user to give an instruction to provide or receive a communication parameter; and
sending means for sending, in case that the operation is detected by the detecting means, a message for enabling the providing apparatus to provide a communication parameter to another receiving apparatus in accordance with a determination result obtained by the determining means.

2. The communication apparatus according to claim 1, further comprising control means for sending the message using the sending means if the determining means determines that the communication apparatus is currently participating in the network, and for controlling the receiving means to operate as the receiving apparatus if the determining means determines that the communication apparatus is not currently participating in the network.

3. The communication apparatus according to claim 1, further comprising changing means for changing, in case that the message is sent, a parameter for determining the number of broadcast signals sent by the communication apparatus per unit time so that the number of broadcast signals sent by the communication apparatus per unit time becomes less than the number of broadcast signals sent by another communication apparatus per unit time.

4. The communication apparatus according to claim 3, further comprising reset means for resetting, upon receipt of a notification of a result of sending/receiving a communication parameter from the other communication apparatus, the parameter changed by the changing means to a parameter before being changed by the changing means.

5. The communication apparatus according to claim 1, further comprising changing means for changing, upon receipt of the message, a parameter for determining the number of broadcast signals sent by the communication apparatus per unit time so that the number of broadcast signals sent by the communication apparatus per unit time becomes less than the number of broadcast signals sent by another communication apparatus per unit time.

6. The communication apparatus according to claim 5, further comprising reset means for resetting, upon receipt of a notification of a result of sending/receiving a communication parameter from the other communication apparatus, the parameter changed by the change means to a parameter before being changed by the changing means.

7. The communication apparatus according to claim 1, further comprising notification means for notifying, upon receipt of a notification of a result of sending/receiving a communication parameter from another communication apparatus, the user of the result of sending/receiving a communication parameter, on the basis of the received notification of the result.

8. The communication apparatus according to claim 1, further comprising a button operated by the user to give an instruction to provide or receive a communication parameter, wherein the detecting means detects an operation of the button by the user.

9. A communication apparatus, comprising:
detecting means for detecting an operation entered by a user to give an instruction to provide or receive a communication parameter;
providing means for operating as a providing apparatus that provides a communication parameter to a receiving apparatus that receives a communication parameter; and receiving means for receiving a message requesting start of an operation as the providing apparatus, the message being sent from a first communication apparatus that is currently participating in a network and that is instructed by the user to provide a communication parameter, wherein, in case that the receiving means receives the message and a request is made by a second communication apparatus, the providing means provides a communication parameter for participating in the network to the second communication apparatus.

10. The communication apparatus according to claim 9, further comprising changing means for changing, upon receipt of the message, a parameter for determining the number of broadcast signals sent by the communication apparatus per unit time so that the number of broadcast signals sent by the communication apparatus per unit time becomes greater than the number of broadcast signals sent by another communication apparatus per unit time.

11. The communication apparatus according to claim 10, further comprising reset means for resetting the parameter changed by the setting means to a parameter before being changed by the setting means, in case that providing of the communication parameter by the providing means is completed, providing of the communication parameter by the providing means is terminated due to an error, a message indicating a notification of completion of sending/receiving a communication parameter is received, or a message indicating a notification of an error in sending/receiving a communication parameter is received.

12. The communication apparatus according to claim 9, further comprising notification means for notifying the user of a result of sending/receiving a communication parameter, in case that providing of the communication parameter by the providing means is completed, providing of the communication parameter by the providing means is terminated due to an error, a message indicating a notification of completion of sending/receiving a communication parameter is received, or a message indicating a notification of an error in sending/receiving a communication parameter is received.

13. The communication apparatus according to claim 9, further comprising a button operated by the user to give an instruction to provide or receive a communication parameter, wherein, if the operation of the button is detected and the request is made by the second communication apparatus, the providing means provides the communication parameter for participating in the network to the second communication apparatus.

14. A control method for a communication apparatus, comprising:
a receiving step of performing a process of receiving, upon detection of an operation entered by a user to give an instruction to provide or receive a communication parameter, from a providing apparatus that provides a communication parameter, a communication parameter in accordance with a result of determining whether the communication apparatus is currently participating in a network; and
a sending step of sending, upon detection of the operation entered by the user to give the instruction to provide or receive a communication parameter, a message for enabling the providing apparatus to provide a communication parameter to another receiving apparatus in accordance with the result of determining whether the communication apparatus is currently participating in the network.

15. A control method for a communication apparatus, comprising:
a detecting step of detecting an operation entered by a user to give an instruction to provide or receive a communication parameter;
a first providing step of operating, if the operation is detected in the detecting step, as a providing apparatus that provides a communication parameter to a receiving apparatus that receives a communication parameter;
a receiving step of receiving a message requesting start of an operation as the providing apparatus, the message being sent from a first communication apparatus that is currently participating in a network and that is instructed by the user to provide a communication parameter; and
a second providing step of providing, if the message is received in the receiving step and a request is made by a second communication apparatus, a communication parameter for participating in the network to the second communication apparatus.

16. A computer readable storage medium storing a computer program for causing a computer to perform the control method according to claim 14.

17. A computer-readable storage medium storing a computer program for causing a computer to perform the control method according to claim 15.
